(19) United States
(12) Patent Application Publication
(10) Pub. No.: US 2022/0370844 A1
(43) Pub. Date: Nov. 24, 2022

(54) CAP ASSEMBLY FOR A CONTAINER AND METHOD OF USING SAME FOR EXTINGUISHING A FIRE

(71) Applicant: Garen ARAKELIAN, Yerevan (AM)

(72) Inventors: Garen ARAKELIAN, Yerevan (AM); Norman BEDARD, Saint-Joseph-de-Coleraine (CA)

(73) Assignee: Garen ARAKELIAN, Yerevan (AM)

(21) Appl. No.: 17/386,747

(22) Filed: Jul. 28, 2021

Related U.S. Application Data
(60) Provisional application No. 63/190,308, filed on May 19, 2021.

(51) Int. Cl. A62C 31/02; B65D 41/04; B65D 51/24; B65B 31/04

(52) U.S. Cl. CPC A62C 31/02; B65D 41/04; B65D 51/24; B65B 31/046

(57) ABSTRACT

The present invention relates to a cap assembly for converting a container of a carbonated drink into a fire extinguishing device. The present invention also relates to a method for extinguishing a fire using a container of water or carbonated drink producing environmentally friendly and human safe stream.

### CROSS-REFERENCE

The present application claims priority to U.S. Provisional Patent Application No. 63/190,308, filed May 19, 2021, entitled “Cap Assembly for a Container and Method of Using Same for Extinguishing a Fire.”

### TECHNICAL FIELD

The invention relates to a fire cap assembly to be used with available water bottles and carbonated drinks.

### BACKGROUND OF THE ART

Due to the environmental conditions, especially in warm and dry regions like Australia and California, a small bush fire can turn into a high cost widespread inferno costing billions of dollars. Fires can obviously be contained more easily when they have just started or when they are limited. Therefore, fighting the fire in the first few minutes is of utmost importance, and there may be benefits for regular citizens to act prior to the arrival of firefighting teams.

To do so, however, citizens are provided with limited options. On one hand, they can rely on the use of garden hoses. However, typical garden hoses may not be sufficiently long to reach remote locations where bush fires can spread and water supply is often cut by the authorities in the locations where bush fires start.

Alternatively, citizens can make use of fire extinguishers. The fire extinguishers currently available on the market typically weight from 1 kg to 23 kg. They tend to be expensive (at least 15 USD) and, even if they are not used, the user has to recharge them on a regular basis (e.g., every 5 years). These fire extinguishers are professional equipment and if they are used correctly and for the right application, they can indeed be useful to extinguish fires. However, they tend to be heavy (the more effective they are, the heavier they generally are), expensive, and often cannot be used against more than one source of fire (e.g., electrical, bush, fossil combustible) or by more than one person, and they may not always be available when the need arises. Further, fire extinguisher's foam tend to be environmentally unfriendly.

On the other hand, citizens often have sources of liquids that are contained in portable containers and can be readily transported to a remote location from their residence, and that could potentially be of assistance in extinguishing or controlling the size of bush fires, especially when they are still small. Such liquid containers include bottles of water or carbonated drinks. While the main purpose of buying such bottled beverage is for human consumption, from a pure cost perspective, people are more likely to buy a 2-liter Coke™ or a bottle of water than a fire extinguisher. Further, the probability of having a bottle of water or a bottle of carbonated drink during outdoor activities in remote locations where bush fires are susceptible to occur is much higher than the probability of having a portable fire extinguisher.

Resorting to such bottled beverages to extinguish fires may present some risks, as the efficiency of the extinguishing procedure may involve the user to physically approach the fire in order to pour or spread the liquid in appropriate areas.

It would be advantageous to be provided with a device and a method for extinguishing fires that relies on the use of bottled liquids or beverages and can keep the user safe, while producing a fire extinguishing mixture that is environmentally friendly and safe for humans and human consumption.

### SUMMARY

According to a broad aspect, there is provided a cap assembly for a container capable of containing a liquid, the cap assembly comprising:
a cap including a container securing portion for securing the cap to the container, and a liquid ejection portion mounted to the container securing portion, the liquid ejection portion including at least one opening configured for allowing a passage of the liquid contained in the container to the exterior thereof when a pressure is exerted on the liquid contained in the container.

In one feature the container is selected from a group consisting of a bottle and a can.

In another feature, the liquid contained in the container comprises water or a carbonated liquid. Preferably, the carbonated liquid is a carbonated drink.

In still another feature, the ejection portion of the cap further comprises an inlet opening for delivering a CO₂ producing product into the container.

In yet another feature, the container comprises a bottle having a threaded neck, and the container securing portion of the cap comprises a cylindrical jacket configured to engage the threaded neck of the container. Preferably, the cylindrical jacket comprises threads configured to engage the threaded neck of the bottle.

In a different feature, the cap assembly further comprises a removable cover securable to at least one of the containers securing portion and the liquid ejection portion of the cap, the cover being configured for concealing the opening of the liquid ejection portion and to prevent unwanted passage of the liquid contained in the container through the opening.

According to another broad aspect, there is provided the use of a cap assembly as herein described to convert a container of a liquid into a fire extinguishing device.

According to yet another broad aspect, there is provided a method for extinguishing a fire, the method comprising:
providing a cap assembly as defined herein;
securing the cap assembly to a container containing a liquid;
applying a pressure on the liquid contained in the container, the pressure being sufficient to force the liquid contained in the container to be expelled by the opening of the ejection portion of the cap assembly and to define a liquid jet;
directing the liquid jet towards the fire to be extinguished.

In one feature, the step of applying pressure on the liquid contained in the container is carried out by delivering a CO₂-producing composition into the liquid contained in the container.

### BRIEF DESCRIPTION OF THE DRAWINGS

Having thus generally described the nature of the invention, reference will now be made to the accompanying drawings, showing by way of illustrations example embodiments thereof and in which:

FIG. 1 is a top perspective view of a fire cap assembly mounted to a container of carbonated liquid, in accordance with one embodiment;

FIG. 2 an exploded, top perspective view of the fire cap assembly and container shown in FIG. 1;

FIG. 3 a close-up exploded, top perspective view of the fire cap assembly and container shown in FIG. 1;

FIG. 4 is a top perspective view of a fire cap in accordance with one embodiment;

FIG. 5 is a front elevation view of the fire cap shown in FIG. 4;

FIG. 6 is a back elevation view of the fire cap shown in FIG. 4;

FIG. 7 is a left side view of the fire cap shown in FIG. 4;

FIG. 8 is a right side view of the fire cap shown in FIG. 4;

FIG. 9 is a top view of the fire cap shown in FIG. 4;

FIG. 10 is a bottom view of the fire cap shown in FIG. 4;

FIG. 11 is a bottom perspective, cross-sectional view of the fire cap shown in FIG. 4;

FIG. 12 shows top and bottom views of a cover shown in accordance with one embodiment;

FIG. 13 is a close-up perspective, cross-sectional view of the fire cap assembly and container shown in FIG. 1;

FIG. 14 is a close-up perspective, cross-sectional view of the fire cap assembly and container shown in FIG. 1, further showing a syringe injecting a CO₂ producing liquid, and the path of the liquid being expelled from the container;

FIG. 15 is a cross-sectional view of a fire cap assembly in accordance with an alternative embodiment;

FIG. 16 is a close-up perspective, cross-sectional view of the fire cap assembly shown in FIG. 15, along with a syringe for injecting a CO₂ producing liquid;

FIG. 17 is a cross-sectional view of the fire cap assembly shown in FIG. 15, along with a container; and

FIG. 18 is a front elevation view of the fire cap shown in FIG. 15.

### DETAILED DESCRIPTION

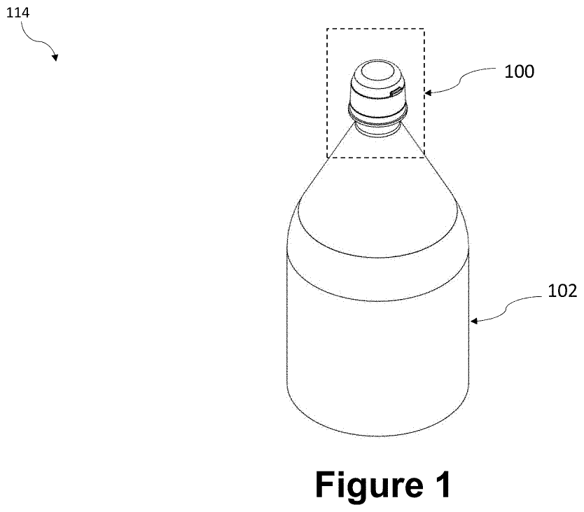

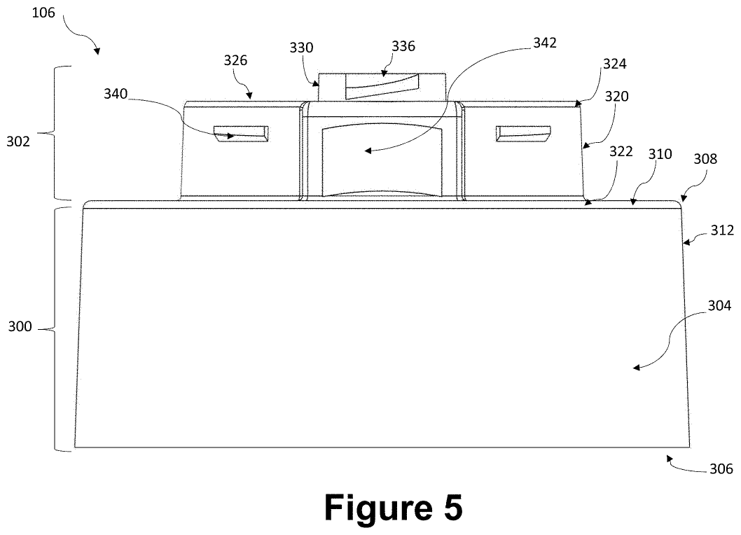

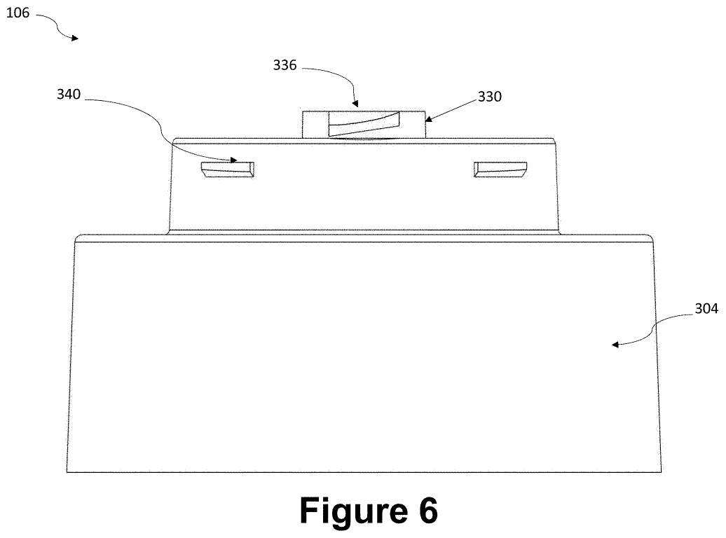

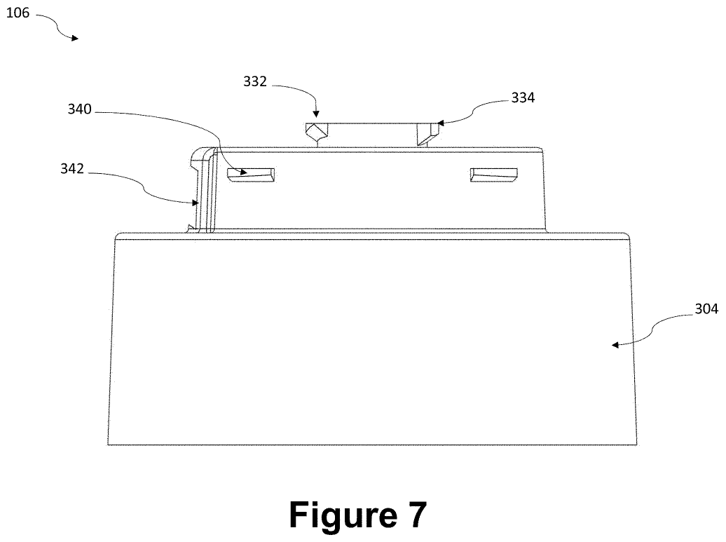

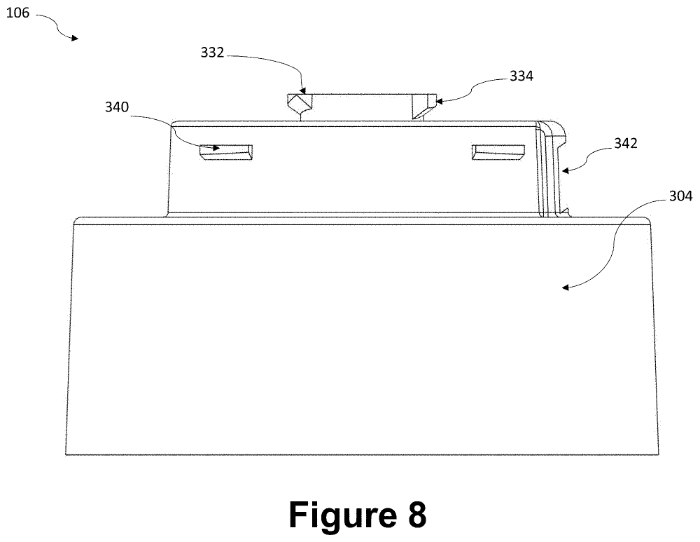

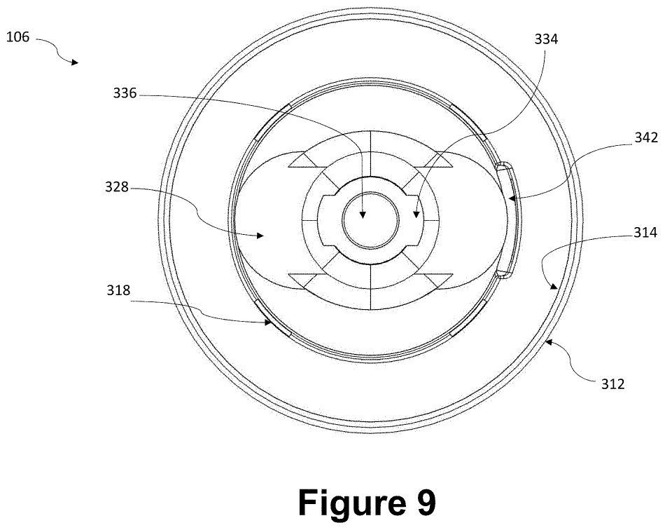

With reference to FIGS. 1 to 14, there will be described a fire cap assembly 100 for use in conjunction with a container 102. As it will become apparent below, the fire cap assembly 100 is configured to collaborate with a neck portion 104 of the container 102 to removably secure the fire cap assembly 100 to the container 102 in order to allow a user to drink the liquid contained in the container and/or to secure the fire cap assembly to a container having a standardized configuration of neck portion 104 such as a bottle of carbonated drink. As such, the fire cap assembly 100 of the invention can be combined with available water bottles or containers of carbonated drinks, and may find particular application in the field of fire extinguishers to fight the fire at the initial steps or to use them to create a “wall of water” to give people more time to leave a scene where fire spreads. Alternatively, if there are no fires, the fire cap assembly 100 can be used for recreational purposes.

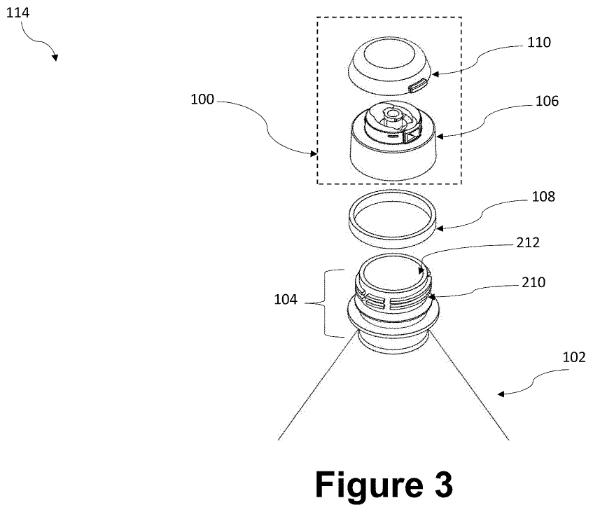

With reference to FIG. 3, the fire cap assembly 100 comprises a fire cap 106 securable to the neck portion 104 of the container 102, and a cover 110 for closing the fire cap 106, as it will be described in greater details below. In the illustrated embodiment, the container 102 carries a tampering band 108, which is a relic of a cap (not shown) previously installed on the container 102 (e.g., the cap installed at the bottling facility) and subsequently removed to allow the use of the fire cap assembly 100.

### Fire Cap

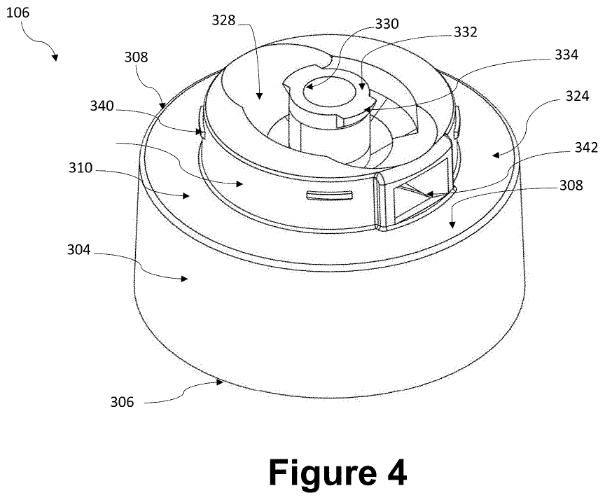

Turning now to FIGS. 4 to 11, the fire cap 106 will now be described. In the illustrated embodiment, the fire cap 106 comprises a lower portion 300 configured to removably engage the neck portion 104 of the container 102, and an upper portion 302 integrally formed with the lower portion 300. As it will become apparent below, the upper portion 302 of the fire cap 106 is configured for allowing injection of a carbonating fluid in the container 102, and for projecting or expelling the liquid contained in the container 102 to extinguish a fire.

More particularly, the lower portion 300 of the fire cap 106 is configured to engage the neck portion 104 of the container 102, and generally includes a cylindrical jacket 304 having a lower end 306 and an upper end 308, the upper end 308 of the lower portion 300 being closed by a top external fire cap surface 310. The cylindrical jacket 304 has an external surface 312, which extends between the lower end 306 and the upper end 308, and which can optionally be provided with gripping means to increase frictional engagement when the fingers of a user grab the lower portion 300 of the fire cap 106, to screw or unscrew the fire cap assembly 100 to the container 102. The cylindrical jacket 304 also has an internal surface 314 provided with a cap fastening means 316, for engaging the neck portion 104 of the container 102. In the illustrated embodiment, the cap fastening means 316 comprises a plurality of radially and inwardly projecting tabs 318 distributed in a thread pattern, the inwardly projecting tabs 318 being sized, shaped and positioned to collaborate with a thread 210 defined on the neck portion 104 of the container 102 (best shown in FIG. 3), as it will be apparent to the skilled addressee. In other words, the thread 210 of the container 102 and the cap fastening means 316 are complementary such that when the fire cap assembly 100 is received on the neck portion 104 of the container 102, the fire cap assembly 100 can be screwed onto the container 102.

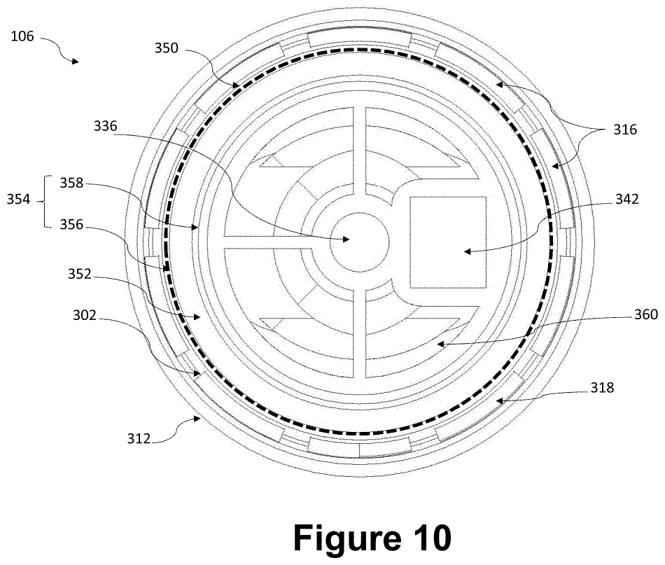

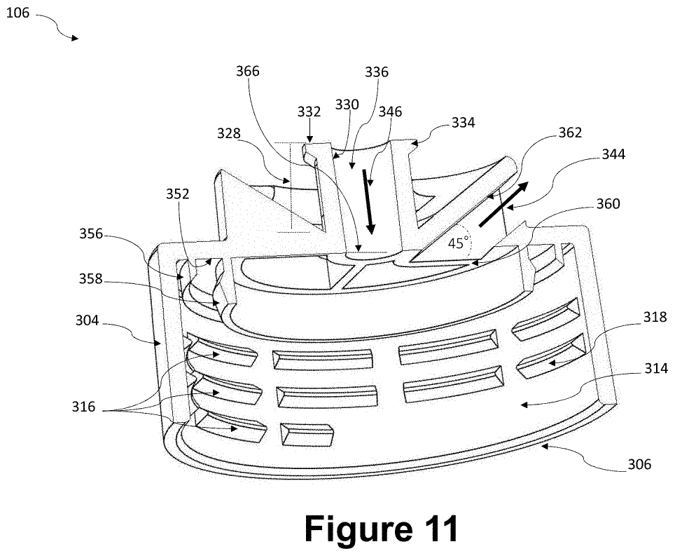

The cylindrical jacket 304 of the fire cap 106 also has an internal top surface 352, provided with a cap sealing means 354 for engaging an upper end 212 of the neck portion 104 of the container 102. In the illustrated embodiment, the cap sealing means 354 comprises an outer sealing ring 356 and an inner sealing ring 358, the outer and inner sealing rings 356 and 358 being sized, shaped and positioned to collaborate for providing seal between the upper end 212 on the neck portion 104 of the container 102 and the fire cap 106 (best shown in FIGS. 10 and 11) as it will be apparent to the skilled addressee. In other words, the upper end 212 of the neck portion and the cap sealing means 354 are complementary such that the inner portion surface 360 of the fire cap 106 abuts against the upper end 212 of the neck portion 104 of the container 102 (best shown in FIGS. 10 and 11).

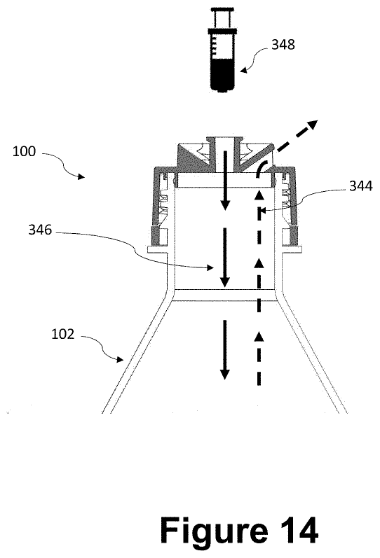

The upper portion 302 of the fire cap 106 is integrally formed with the lower portion 300 and comprises an annular wall 320 having a lower end 322 (adjacent to the top surface 310 of the lower portion 300) and an upper end 324. The annular wall 320 extends coaxially to the cylindrical jacket 304 of the lower portion 300. The upper portion 302 also comprises a top wall 326, extending generally orthogonally to the annular wall 320, at the upper end 324 thereof. Defined in the top wall 326 of the upper portion 324 is a recess 328, in which upwardly extends a cylindrical projection 330 for securing thereon a liquid injection means such as a syringe 348 for injecting a carbonating liquid into the container 102 (schematically shown in FIG. 14). Extending radially from the cylindrical projection 330, at an upper end 332 thereof, is a pair of tabs 334 configured for engaging threads such as those commonly found at a tip of a syringe, thus allowing removably securing the syringe 348 to the fire cap 106, as it will be described in greater details below. Defined in the cylindrical projection 330 is an inlet opening 336, extending from the upper end 332 of the cylindrical projection to a lower end 366 thereof, the inlet opening 336 allowing the injection of a fluid inside the fire cap assembly 100. As such, when the fire cap assembly 100 is mounted to the container 102, and a fluid injection means such as syringe 348 is secured to the cylindrical projection 330, a liquid contained in the fluid injection means can be injected through the fire cap 106, into the container 102, to be mixed with the liquid already contained therein (e.g., carbonated water), as it will be described in greater details below.

Extending radially from the annular wall 320 is a plurality of projections 340 configured to engage the cover 110, and to maintain the same in a closed position, as it will become apparent below.

Defined in the annular wall 320 of the fire cap 106 is an outlet opening 342. The outlet opening 342 is configured to define a jet nozzle for projecting or expelling the liquid 344 contained in the container 102 when a pressure is applied on thereon either directly or indirectly. As it will be appreciated, the pressure exerted on the liquid contained in the container 102 can result from the liberation of the CO₂ but in some instances, it could also result from a pressure exerted manually on the container contained (e.g., by compressing the container 102 if it is made of a compressible or a semi-compressible material), by injecting a pressure of gas through the opening 336 of projection 330, or a combination thereof.

In the illustrated embodiment, and referring more specifically to FIG. 11, the outlet opening 342 is surrounded (or defined by) a channel wall 362 defining a conduit extending at an angle of 45 degrees with respect to the inner portion surface 360 of the fire cap 106. As such, when the liquid is expelled from the opening 342, it is projected at a corresponding angle of 45 degrees, whether the container 102 equipped with the fire cap 106 is positioned upright on the ground (in a normal position) or is positioned such as to rest on it side. Alternatively, users can put the container 102 equipped with the fire cap 106 in a down facing position to expel the liquid contained in the container 102, while opening more similar containers. The fluid leaving the opening will thus travel a distance and humidify the ground, from the place the container 102 is positioned up to the end point of the jet. As it will be appreciated, this angle of 45 degrees provides for a number of container positioning possibilities and allows the user to open more bottles and have more time to leave the fire location. Further, by configuring the channel wall 362 at an angle of 45 degrees, it is possible to size the opening 342 larger than if the channel would be positioned differently. It will however be understood that in some instances, it may be desirable to position the channel wall 362 at a different angle, without departing from the scope of the embodiment.

Further, it will be appreciated that in the illustrated embodiment, the channel wall 362 and the opening are fixed. In other words, their position cannot change as the opening 342 is integrally formed with the fire cap 106.

### Cover

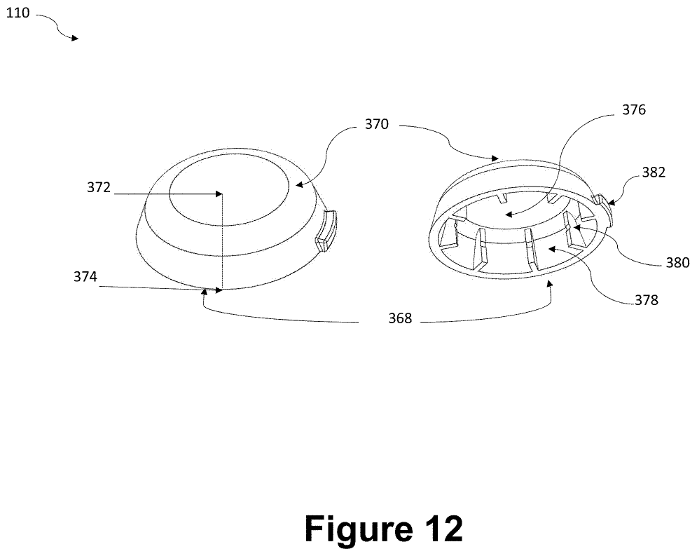

Turning now to FIG. 12, the cover 110 will now be described. In the illustrated embodiment, the cover 110 comprises an inner surface 368 and an outer surface 370, as well as an upper end 372 and a lower end 374. An upper part 376 of the cover 110 has a first inner dimension, and is convex. A lower part 378 of the cover 110 has a second inner dimension that is wider than the first inner dimension of the upper part 376. The second inner dimension of the lower portion 378 of the cover 110 is selected so as to fit snugly around the upper end 308 of the jacket 300 of the fire cap 106 in a sliding engagement. The inner surface 368 of the lower part 378 has at least eight inwardly notches or snap groove 380, the size of which is designed to receive therein projection snap beads 340 extending radially from the annular wall 320 of the fire cap 106 by snap-fitting engagement. Preferably, eight projection snap beads 340 are provided on the annular wall 320 of the fire cap 106 in a circumferentially discontinuous arrangement configuration. Alternatively, the projection snap beads 340 could be replaced with a single snap bead, circumferentially continuous on the annular wall 320 of the fire cap 106. A tab 382 is provided at the lower end 374 of the outer surface 370, to enable a user to open and close the cover 110 to access the fire cap 106.

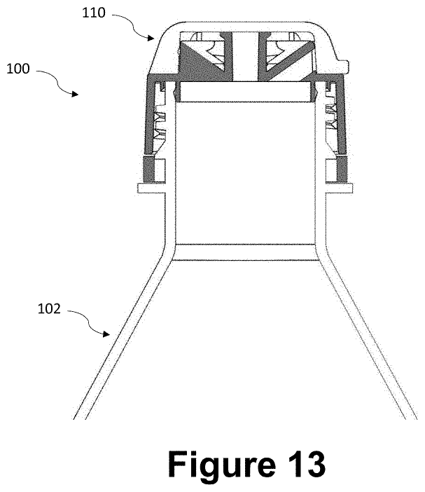

By pressing the cover 110 onto the fire cap 106, the plurality of projection snap beads 340 extending radially from the annular wall 320 engage the notches 380 of the cover 110. As a result, the cover 110 can be secured to the fire cap 106 in a force-fitting or form-fitting manner. FIG. 13 further shows that insert cover notches 380 are held in the receiving projections snap beads 340 of the fire cap 106.

The cover 110 is preferably mounted to the jacket 300 of the fire cap 106 via a hinge (not shown). In an alternative embodiment, the cover 110 does not necessarily have to be connected to the fire cap 106 via a hinge (not shown), but rather be designed as a separate removable part, for example, it could be designed to engage the “syringe engaging portion” (not shown) of the fire cap.

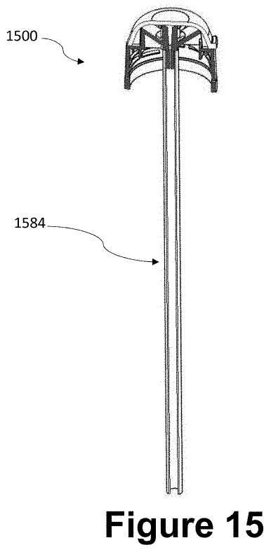

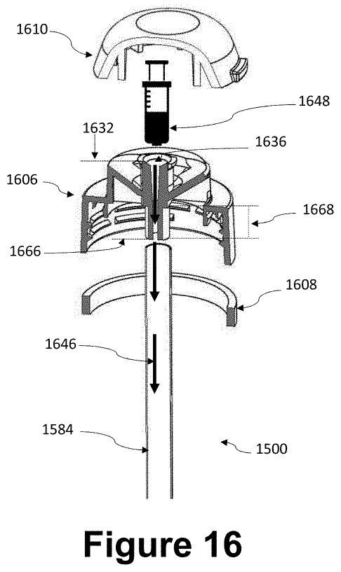

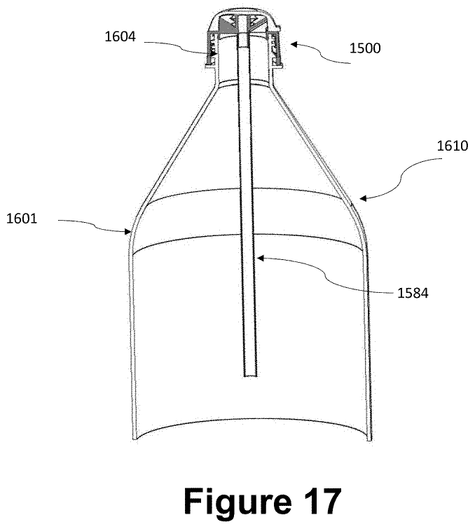

Turning now to FIGS. 15 to 18, another embodiment of the fire cap assembly 1500 receivable on a container 1601 will be described. The fire cap assembly 1500 is similar to the fire cap assembly 100, except that it is configured to be provided with a tube 1584 for conveying the carbonating fluid towards the bottom of the container 1601. As such, the fire cap assembly 1500 comprises a fire cap 1606 securable to the neck portion 1604 of the container 1601, and a cover 1610 for closing the fire cap 1606.

Much like the fire cap 106, the fire cap 1606 comprises a lower portion 1600 configured to removably engage the neck portion 1604 of the container 1601, and an upper portion 1602 integrally formed with the lower portion 1600, and configured for injecting the carbonating fluid in the container 1602 and projecting or expelling the liquid contained in the container 1601 to extinguish a fire, as it will become apparent below.

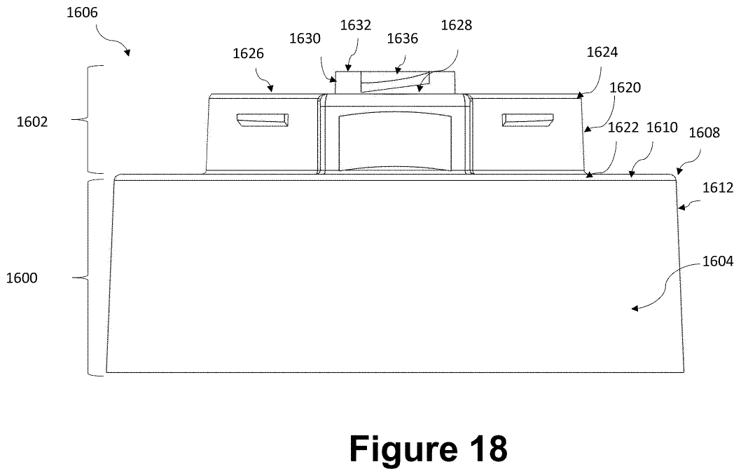

The upper portion 1602 of the fire cap 1606 is integrally formed with the lower portion 1600 and comprises an annular wall 1620 having a lower end 1622 (adjacent to the top surface 1610 of the lower portion 1600), and an upper end 1624. The annular wall 1620 extends coaxially to the cylindrical jacket 1604 of the lower portion 1600. The upper portion 1602 also comprises a top wall 1626, extending generally orthogonally to the annular wall 1620, at the upper end 1624 thereof. Defined in the top wall 1626 of the upper portion 1624 is a recess 1628, in which upwardly extends a cylindrical projection 1630 for securing thereon a liquid injection means such as a syringe 1648 (schematically shown in FIG. 18). Defined in the cylindrical projection 1630 is an inlet opening 1636, which extends from an upper end 1632 of the cylindrical projection 1630 to a lower end 1666 thereof. The inlet opening 1636 allowing the passage of a fluid though the fire cap 1606, into the container 1601.

As best shown in FIG. 18, the cylindrical projection 1630 is provided with a spout portion 1668 extending downwardly, between an intermediate location (corresponding essentially to the location of the surface 1610 of the lower portion 1600) and the lower end 1666. The spout portion is configured to snuggly engage the inner side of the tube 1584, to secure the tube 1584 to the fire cap 1506. As it will be appreciated, the tube 1584 defines an extension of the inlet opening 1636. As such, the fire cap 1606 provides a path through the fire cap 1606 and through the tube 1584, to the container 1601 to inject a CO₂ producing liquid 1646 into bottom area of the container 1602. As such, when the fire cap assembly 1500 is mounted to the container 1601, and a fluid injection means such as the syringe 1648 is secured to the cylindrical projection 1630, the liquid contained in the syringe 1648 can be injected through the fire cap 1606 and the tube 1584 into the container 1602, to be mixed with the liquid already contained in the container 1602 (e.g., carbonated water).

### Materials

As stated above, fire cap assemblies 100 and 1500 are configured to be used in conjunction with containers 102 and 1601, respectively. The containers 102 or 1601 include containers and bottles made of various sizes and shapes. Preferably, the fire cap assemblies 100 or 1500 are sized and shaped to be received or mounted to a conventional neck 104 of the container 102 such as conventional bottles.

In one embodiment, the containers 102 or 1601 include containers and bottles made of various materials, including but not limited to polymer materials, glass, metals, ceramics, aluminum-plastic composite materials or paper-plastic composite materials, or composite types of the above materials.

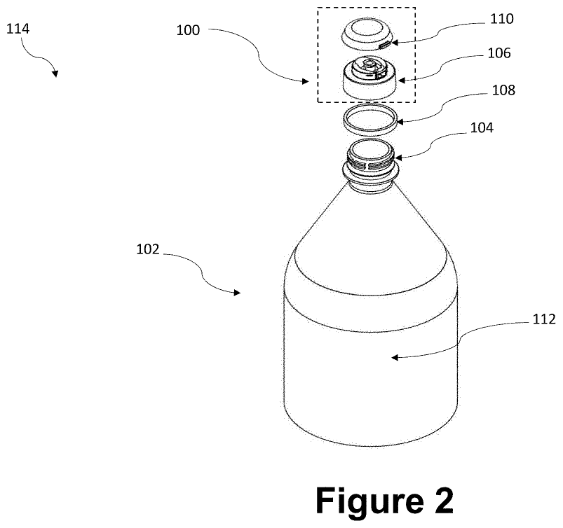

As such, in one embodiment, the containers 102 or 1601 are each made of a single material, for instance a plastic material. In a further embodiment, the containers 102 or 1601 each consist of a unitary structure. Alternatively, each of the containers 102 or 1601 could be manufactured as an assembly or composition of separate parts. Taking container 102 as an example, is could be manufactured as an assembly of the neck 104 of the container 102 and a main chamber 112 of the container 102. For example, the neck structure 104 of the container 102 and the main chamber structure 112 of the container 102 are assembled together to form a container 102, or the neck 104 of the container 102 and the main chamber structure 112 of the container 102 are welded together to form the container 102 (best shown in FIG. 2).

The containers 102, 1601 are preferably made of polymer materials such as plastic, plastic materials, or made of glass or ceramic materials, or made of metal materials such as steel, aluminum, tin, copper and other metals or composite metals. For example, polymer materials include but are not limited to polyethylene terephthalate (PET), polycarbonate (PC), polystyrene (PS), polypropylene (PP), high-density polyethylene (HDPE), low-density polyethylene (LDPE), polyethylene (PE), polyvinyl chloride (PVC), as well as paper-plastic materials, aluminum-plastic composite materials, etc., but the materials are not limited to any specific one.

The fire cap assemblies 100 or 1500 are preferably made of polymer materials such as plastic, plastic materials, or made of glass or ceramic materials, or made of metal materials such as steel, aluminum, tin, copper and other metals or composite metals. For example, polymer materials include but are not limited to polyethylene terephthalate (PET), polycarbonate (PC), polystyrene (PS), polypropylene (PP), high-density polyethylene (HDPE), low-density polyethylene (LDPE), polyethylene (PE), polyvinyl chloride (PVC), as well as paper-plastic materials, aluminum-plastic composite materials, etc., but the materials are not limited to any specific one.

Having described the various components of the fire cap assemblies 100 and 1500, their operation will now be described. For the purpose of this description, the operation of these fire cap assemblies 100 and 1500 will be described using fire cap assembly 100 as an example. It will be understood that a similar description also applies to fire cap assembly 1500, with a proper adaptation.

In a first step, the fire cap assembly 100 is secured to the container 102, if necessary. Then, a user can lift the cover 110 to access the cylindrical projection 330 and the inlet opening 336 extending therethrough.

Using a first syringe (e.g. syringe 348), a first solution (e.g. an acidic solution) is injected into the container 102, through the inlet opening 333. Using a second syringe (e.g. syringe 348), a second solution or mixture (e.g. a carbonate solution) is then injected into the container 102, through the inlet opening 226, where the first and second solutions react together to generate gaseous CO₂.

As the first and second solutions (or mixtures) are mixed with the liquid contained in the container, they generate gaseous CO₂ which in turn, increases the internal pressure in the container 102. In some instances, a single solution could be used to generate gaseous CO₂ or to free the CO₂ dissolved in the carbonated liquid contained in the container 102. As the internal pressure increases, it forces the liquid contained in the container to be expelled through the opening, thus creating a jet of liquid. At that point, the user can direct the jet of liquid towards the fire area he/she wants to extinguish or, alternatively, position the container 102 provided with the fire cap assembly 100 on the ground, with the liquid jet oriented towards a desired direction, and then proceed immediately to use another container 102 provided with a fire cap assembly 100 in the same manner, to increase the number of liquid jets and extinguishing power.

As it will be appreciated, the fire cap assembly 100 is configured for spraying a carbonated liquid contained in the container 102. In some instances, however, the carbonated liquid can have a lower content of CO₂, or even no CO₂ at all. It can thus be desirable to be provided with a means for providing a CO₂ content of a liquid contained in the container 102, or to increasing the level of CO₂ in order to improve the performance of the fire cap assembly 100. As such, in accordance with one embodiment, there is provided a solution for providing or increasing a level of CO₂ in a liquid.

While in the above embodiment, the fire cap assemblies 100 and 1500 are configured to make use of liquid CO₂ producing components, it will be understood that other configurations are possible. For instance, the system for producing CO₂ could include a liquid system and a capsule of free powder or gel suspension pressed tablet system, but is not limited to any specific one. In an alternative embodiment, a capsule of free powder or gel suspension pressed tablet system can be used. Further, one could used compressed CO₂ gas, injected through the cap assemblies 100 and 1500 via a proper injection device.

As it will be appreciated, the fire cap assembly, and the solution, provide a simple and inexpensive design that can turn any carbonated drink or simple bottled water into an environmentally friendly fire-fighting unit, which is also safe for humans and for human consumption.

While in the illustrated embodiments, the cap assembly was described as being securable to a bottle, it will be appreciated that such a cap assembly could be configured to be mounted on other types of containers. For instance, a cap assembly could be configured to be mounted to a top of a can of a carbonated drink, for instance by using a snap engagement means to snap or otherwise engage the upper rim of the can to secure thereon the cap assembly. Further, it will be appreciated that instead of using a liquid solution to create CO₂ or to liberate CO₂ already present in the liquid, a solid composition could be used, for instance Mentos™ candies or effervescent antacid and pain reliever capsules such as Alka-Seltzer™ capsules.

The embodiments described above are intended to be exemplary only. The scope of the invention is therefore intended to be limited solely by the appended claims.

1. A cap assembly for a container capable of containing a liquid, the cap assembly comprising:
a cap including a container securing portion for securing the cap to the container, and a liquid ejection portion mounted to the container securing portion, the liquid ejection portion including at least one opening configured for allowing a passage of the liquid contained in the container to the exterior thereof when a pressure is exerted on the liquid contained in the container.

2. A cap assembly as claimed in claim 1, wherein the container is selected from a group consisting of a bottle and an can.

3. A cap assembly as claimed in claim 1, wherein the liquid contained in the container is a carbonated liquid.

4. A cap assembly as claimed in claim 3, wherein the carbonated liquid comprises water or a carbonated drink.

5. A cap assembly as claimed in claim 1, wherein the ejection portion of the cap further comprises an inlet opening for delivering a CO₂ producing product into the container.

6. A cap assembly a claimed in claim 1, wherein the container comprises a bottle having a threaded neck, and the container securing portion of the cap comprises a cylindrical jacket configured to engage the threaded neck of the container.

7. A cap assembly as claimed in claim 6, wherein the cylindrical jacket comprises threads configured to engage the threaded neck of the bottle.

8. A cap assembly as claimed in claim 1, further comprising a removable cover securable to at least one of the containers securing portion and the liquid ejection portion of the cap, the cover being configured for concealing the opening of the liquid ejection portion and to prevent unwanted passage of the liquid container in the container through the opening.

9. Use of a cap assembly as defined in claim 1 to convert a container of a carbonated drink into a fire extinguishing device.

10. A method for extinguishing a fire, the method comprising:
providing a cap assembly as defined in claim 1;
securing the cap assembly to a container containing a liquid;
applying pressure on the liquid contained in the container, the pressure being sufficient to force the liquid contained in the container to be expelled by the opening of the ejection portion of the cap assembly and to define a liquid jet;
directing the liquid jet toward the fire to be extinguished.

11. A method according to claim 10, wherein the step of applying the pressure on the liquid contained in the container is carried out by delivering a CO₂-producing composition into the liquid contained in the container.
